(19) United States
(12) Patent Application Publication
(10) Pub. No.: US 2016/0075229 A1
(43) Pub. Date: Mar. 17, 2016

(54) Vent valve mount of fuel tank

(71) Applicant: Yu-Peng Chan, Changhua (TW)

(72) Inventor: Yu-Peng Chan, Changhua (TW)

(21) Appl. No.: 14/953,029

(22) Filed: Nov. 27, 2015

(51) Int. Cl. B60K 15/035

(52) U.S. Cl. CPC B60K 15/03519; B60K 2015/03542

(57) ABSTRACT

A vent valve mount of a fuel tank includes a plurality of support rings each including an opening, a circular top platform greater than the opening, and a wall extending from the top platform to the opening; and a plurality of hollow, circular seats disposed on the fuel tank. An inner surface of each seat is secured to both the top platform and the wall of each support ring.

### BACKGROUND OF THE INVENTION

1. Field of the Invention

The invention relates to fuel tanks and more particularly to a mount of a vent valve of an automotive fuel tank.

2. Description of Related Art

A conventional fuel tank B is shown in FIGS. 1 and 1A. The fuel tank B includes two hollow seat B1 each having two opposite projections B11 on the mouth. A vent valve A is mounted on the projections B11 of each seat B1 as shown in FIG. 2.

However, the seats B1 are not durable, thereby limiting the useful life of the fuel tank B. Thus, the need for improvement still exists.

### SUMMARY OF THE INVENTION

It is therefore one object of the invention to provide a vent valve mount of a fuel tank comprising a plurality of hollow, circular seats disposed on the fuel tank; and a plurality of support rings each including an opening, a circular top platform greater than the opening, and a wall extending from the top platform to the opening; wherein an inner surface of each seat is secured to both the top platform and the wall of each support ring.

The above and other objects, features and advantages of the invention will become apparent from the following detailed description taken with the accompanying drawings.

### BRIEF DESCRIPTION OF THE DRAWINGS

FIG. 1 is a perspective view of a conventional automotive fuel tank;

FIG. 1A is a detailed view of the area in an oval of FIG. 1;

FIG. 2 schematically depicts a vent valve mounted on the seat of the conventional fuel tank;

FIG. 3 is a perspective view of an upper portion of an automotive fuel tank according to the invention;

FIG. 3A is a fragmentary view of the seat;

FIG. 3B is a perspective view of the support ring;

FIG. 3C is a fragmentary view of the support ring;

FIG. 4 is an exploded view showing the support ring to be mounted on the bottom of the seat;

FIG. 4A is a perspective view showing the assembled seat and support ring as a mount;

FIG. 5 is a perspective view of the fuel tank according to the invention;

FIG. 6 is a longitudinal sectional view of FIG. 4B; and

FIG. 7 schematically depicts a vent valve mounted on the mount of the fuel tank of the invention.

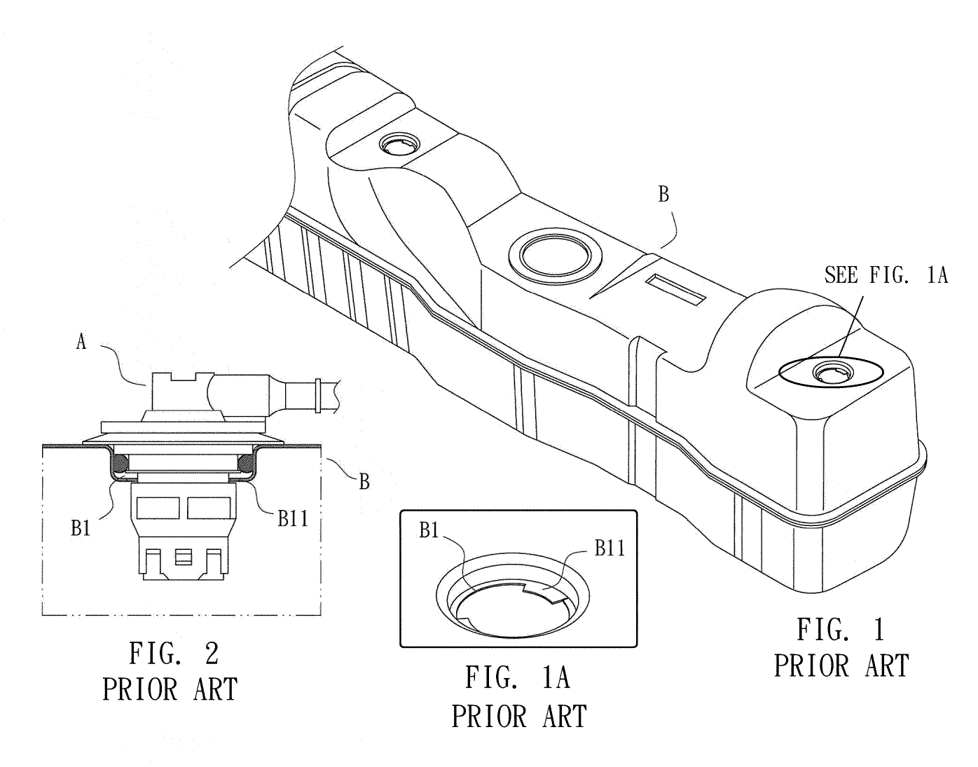

### DETAILED DESCRIPTION OF THE INVENTION

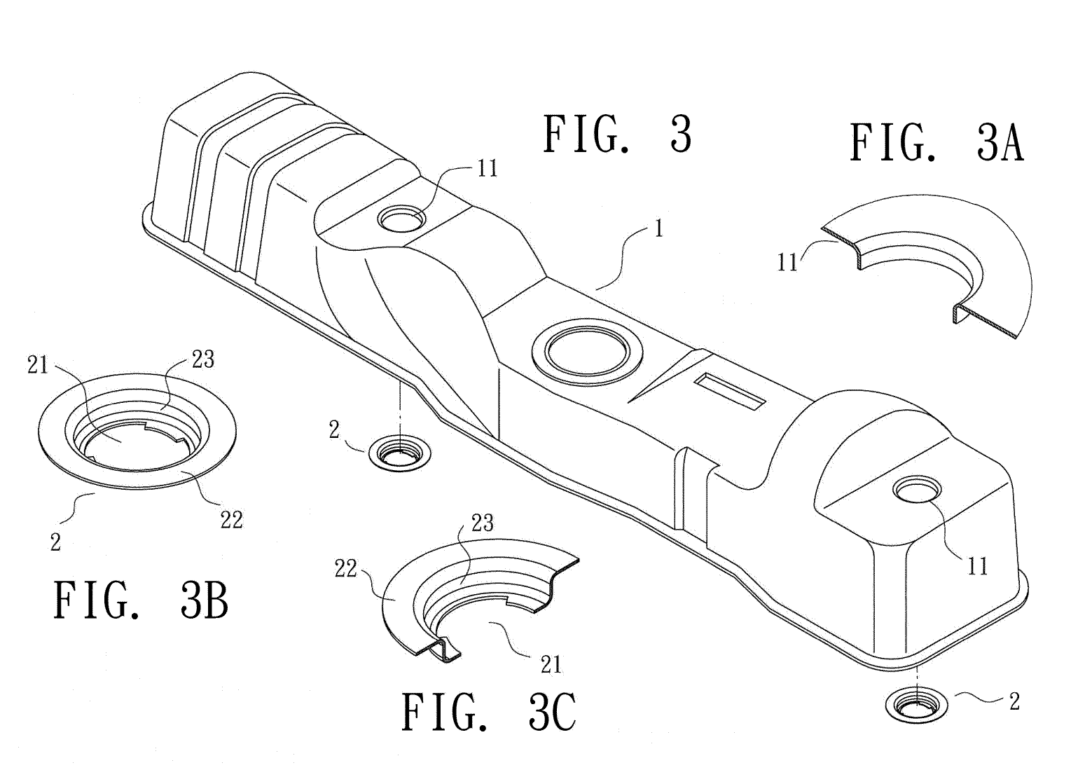

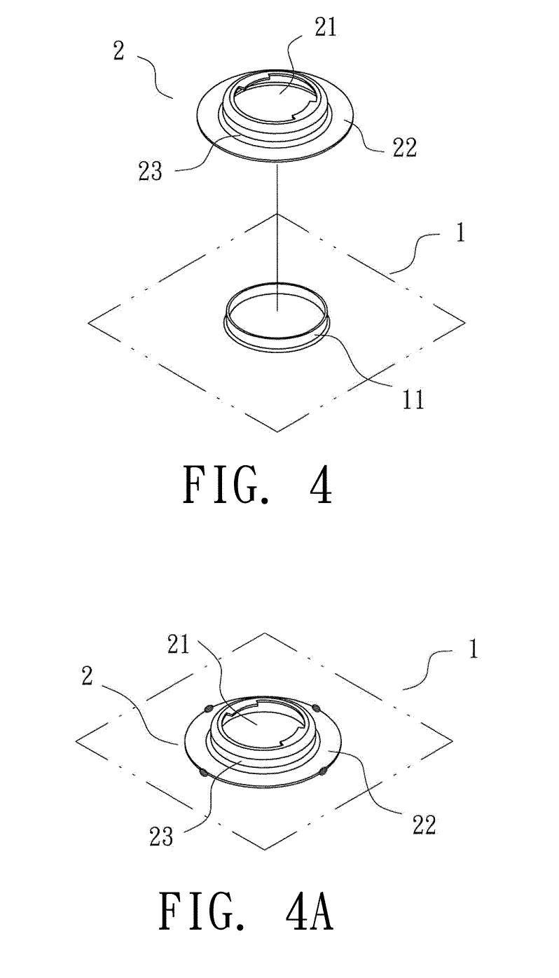

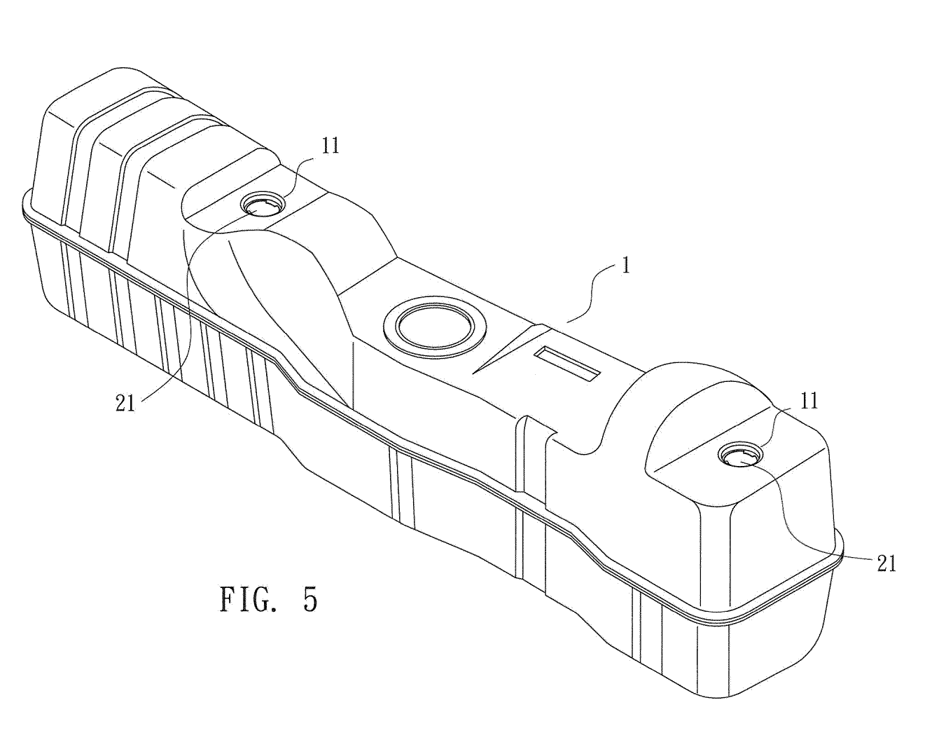

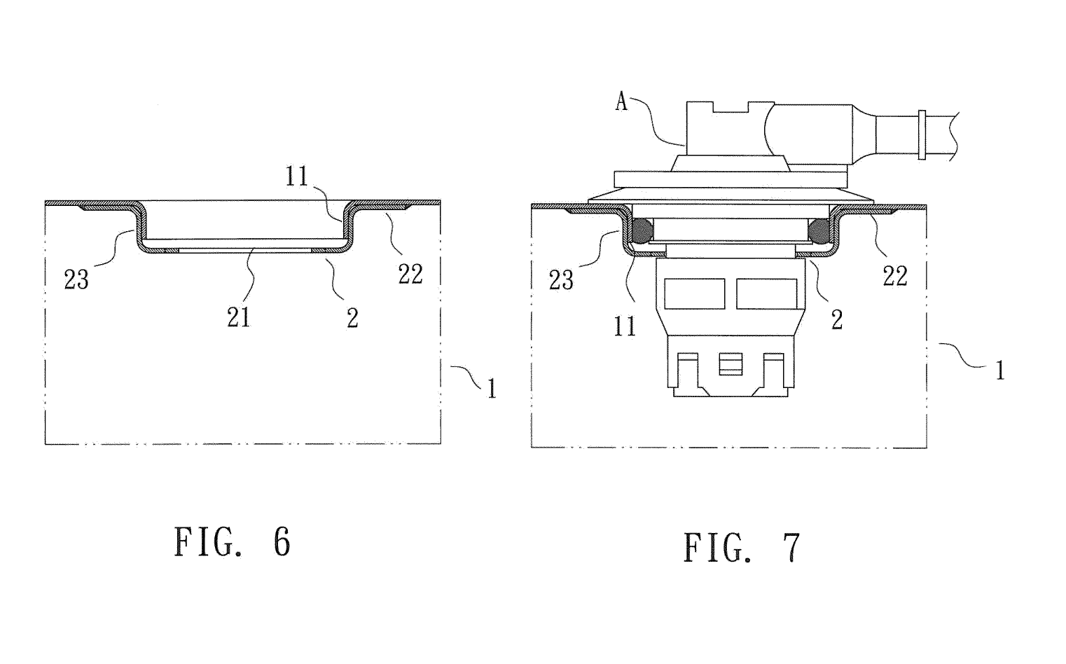

Referring to FIGS. 3 to 7, a mount of an automotive fuel tank 1 in accordance with the invention comprises the following components as discussed in detail below.

Two hollow, circular seats 11 are provided on a top. Two hollow support rings 2 are provided. The support ring 2 includes an opening 21, a circular top platform 22 greater than the opening 21, and a wall 23 extending from the platform 22 to the opening 21. The seat 11 and the support ring 2 are aligned with the platform 22 and the wall 23 secured to an inner surface of the seat 11. A vent valve A is mounted on each seat 11. The seats 11 and the support rings 2 (i.e., the mounts) are durable, thereby prolonging the useful life of the fuel tank 1.

While the invention has been described in terms of preferred embodiments, those skilled in the art will recognize that the invention can be practiced with modifications within the spirit and scope of the appended claims.

What is claimed is:

1. A vent valve mount of a fuel tank comprising:
a plurality of support rings each including an opening, a circular top platform greater than the opening, and a wall extending from the top platform to the opening; and
a plurality of hollow, circular seats disposed on the fuel tank; and
wherein an inner surface of each seat is secured to both the top platform and the wall of each support ring.
